(19) United States
(12) Patent Application Publication
(10) Pub. No.: US 2005/0226176 A1
(43) Pub. Date: Oct. 13, 2005

(54) Telecommunication system with switched chains for uncorrelating correlated noise

(75) Inventors: Dominicus Martinus Wilhelmus Leenaerts, Eindhoven (NL); Gunnar Wetzker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/517,459

(22) PCT Filed: May 27, 2003
(86) PCT No.: PCT/IB03/02301

§ 371 Date: Dec. 8, 2004

(51) Int. Cl. H04J 1/10; H04J 3/08; H04B 7/14

(52) U.S. Cl. 370/315

(57) ABSTRACT

Telecommunication systems comprising transmitting units (1) and receiving units (11), with units (1 resp. 11) comprising parallel chains (2-4 resp. 12-14) coupled to processing parts (5 resp. 15), have enhanced data rates/channel capacities, under the assumption that the noise in the chains (2-4 resp. 12-14) is uncorrelated. Correlated noise from external noise sources decreases said rates/capacities. By coupling said chains (2-4 resp. 12-14) to said processing parts (5 resp. 15) via switches (6 resp. 16) for uncorrelating correlated noise in said chains (2-4 resp. 12-14), any correlated noise present in chains (2-4 resp. 12-14) is made uncorrelated. Said switch (30,50,70) (over/sub)samples chain signals, and is further coupled to said processing part (32,52,72) for controlling purposes to switch randomly or programmedly, with said processing part (32,52,72) and said switch (30,50,70) operating synchronically. Said switch (30,50,70) comprises a (de)multiplexer, with a chain comprising at least an antenna (21,22,41,42,61,62) and possibly an amplifier (25,26,43,44) and a mixer (27,28) coupled via said switch (30,50,70) to said processing part (32,52,72) comprising at least a filter (37,57,77), a converter (38,58,78) and a processor (39,59,79) and possibly said mixer (56,76) and said amplifier (75).

The invention relates to a telecommunication system comprising a transmitting unit and a receiving unit, with at least one unit comprising at least two chains coupled to a processing part.

The invention also relates to a method for exchanging signals in a telecommunication system comprising a transmitting unit and a receiving unit, with at least one unit comprising at least two chains, to a transmitting unit comprising at least two transmitting chains coupled to a transmitting processing part, to a receiving unit comprising at least two receiving chains coupled to a receiving processing part, to a transmitting method for uncorrelating correlated noise in transmitting chains of a transmitting unit comprising said transmitting chains, and to a receiving method for uncorrelating correlated noise in receiving chains of a receiving unit comprising said receiving chains.

Such a telecommunication system is for example a Multi Input Multi Output system or MIMO system, in which a transmitting unit comprises a first number of transmitting chains for parallelly transmitting data, and in which a receiving unit comprises a second number of receiving chains for parallelly receiving data, with said second number being equal to or being different from said first number. By using these parallel chains, enhancement of the data rate and/or the channel capacity can be achieved, under the main assumption that noise in these parallel chains is uncorrelated, with the correlation in the data being known. Other possible examples of such a telecommunication system are cellular radio systems (GSM, UMTS etc.), wireless radio systems (DECT etc.) and wireless networks (LANs, WANs etc.) etc.

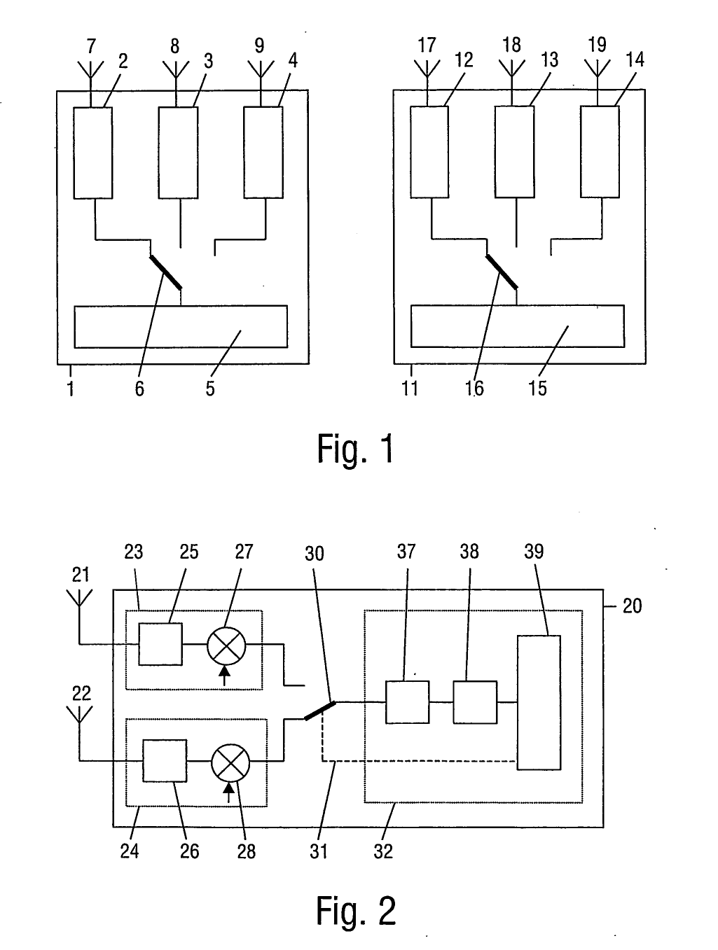

A prior art telecommunication system is known from U.S. Pat. No. 6,314,147, which discloses in its FIG. 1, inter alia, a transmitter (transmitting unit) and a receiver (receiving unit) comprising parallel analog front ends (chains) each coupled to an input of a digital receiver (processing part).

The known telecommunication system is disadvantageous, inter alia, due to certain noise sources introducing correlated noise in the chains. For example when realized on silicon and/or when sharing the same synthesizer, a noise source elsewhere on the silicon and/or said synthesizer will introduce correlated noise in the chains, and this correlated noise lowers the data rate and/or the channel capacity.

It is an object of the invention, inter alia, of providing a telecommunication system as defined in the preamble which can handle noise sources introducing correlated noise in the chains.

The telecommunication system according to the invention is characterized in that said chains are coupled to said processing part via at least one switch for uncorrelating correlated noise in said chains.

Said switch located (serially) between said chains and said processing part switches the chains and couples a first chain during a first interval to the processing part and couples a second chain during a second time interval to the processing part etc. As a result, any correlated noise present in the chains is no longer correlated, due to said correlated noise in said first chain for the rest of the unit only being present during the first time interval and said correlated noise in said second chain for the rest of the unit only being present during the second time interval etc.

The invention is based upon an insight, inter alia, that external noise sources will cause correlated noise in the chains in case of all chains being activated all the time, and is based upon a basic idea, inter alia, that this correlated noise can be made uncorrelated by activating one chain and at the same time deactivating all other chains during (subsequent) time intervals.

The invention solves the problem, inter alia, of providing a telecommunication system as defined in the preamble which can handle noise sources introducing correlated noise in the chains, and is advantageous, inter alia, in that the data rate and/or the channel capacity can be optimal.

It should be noted that U.S. Pat. No. 6,314,147 discloses some kind of switching function, but firstly this switching function is located inside the digital receiver, secondly there is no switch located serially between chains and processing part, this switching function is located parallelly to the chains, and thirdly this switching function is for controlling purposes only and not for uncorrelating any correlated noise in the chains.

A first embodiment of the telecommunication system according to the invention as defined in claim 2 is advantageous in that said switch samples, oversamples or subsamples signals destined for and/or originating from said chains.

Said switch samples, oversamples or subsamples signals destined for the chains in case of being located in the transmitting unit. Said switch samples, oversamples or subsamples signals originating from the chains in case of being located in the receiving unit. When sampling, the original signal in a chain can be restored, when oversampling, the original signal in a chain can be restored, with now however more information being available. When subsampling, the original signal in a chain can not be restored, and estimations must be made.

A second embodiment of the telecommunication system according to the invention as defined in claim 3 is advantageous in that said switch is further coupled to said processing part for controlling purposes.

By coupling said switch and said processing part, the switching can be done randomly or programmedly, with said processing part and said switch always operating synchronically.

A third embodiment of the telecommunication system according to the invention as defined in claim 4 is advantageous in that said switch comprises a demultiplexer and/or a multiplexer.

By realizing said switch through a demultiplexer in case of being located in the transmitting unit and through a multiplexer in case of being located in the receiving unit, the switch is realized low costly and can be implemented well.

A fourth embodiment of the telecommunication system according to the invention as defined in claim 5 is advantageous in that said chains each comprise an antenna, an amplifier and a mixer, which mixer is coupled via said switch to said processing part comprising a filter, a converter and a processor.

In this fourth embodiment, correlated noise in the analog chains each comprising a high number of analog components like the antenna, an analog amplifier and an analog mixer is advantageously uncorrelated, with each chain however disadvantageously comprising said high number of analog components. Said processing part comprises an analog filter, a Digital-to-Analog (DA) converter in case of forming part of the transmitting unit and an Analog-to-Digital (AD) converter in case of forming part of the receiving unit, and a digital processor.

A fifth embodiment of the telecommunication system according to the invention as defined in claim 6 is advantageous in that said chains each comprise an antenna and an amplifier, which amplifier is coupled via said switch to said processing part comprising a mixer, a filter, a converter and a processor.

In this fifth embodiment, correlated noise in the analog chains each comprising an average number of analog components like the antenna and an analog amplifier is advantageously uncorrelated, with each chain comprising said average number of analog components. Said processing part comprises an analog mixer, an analog filter, a Digital-to-Analog (DA) converter in case of forming part of the transmitting unit and an Analog-to-Digital (AD) converter in case of forming part of the receiving unit, and a digital processor.

A sixth embodiment of the telecommunication system according to the invention as defined in claim 7 is advantageous in that said chains each comprise an antenna, which antenna is coupled via said switch to said processing part comprising an amplifier, a mixer, a filter, a converter and a processor.

In this sixth embodiment, correlated noise in the analog chains each comprising a low number of analog components like the antenna is advantageously uncorrelated, with each chain advantageously comprising said low number of analog components. Said processing part comprises an analog amplifier, an analog mixer, an analog filter, a Digital-to-Analog (DA) converter in case of forming part of the transmitting unit and an Analog-to-Digital (AD) converter in case of forming part of the receiving unit, and a digital processor. In case of the switch being coupled directly to the analog amplifier the amplifier noise could however be increased disadvantageously.

Embodiments of the method according to the invention, of the transmitting unit according to the invention, of the receiving unit according to the invention, of the transmitting method according to the invention and of the receiving method according to the invention correspond with the embodiments of the telecommunication system according to the invention.

These and other aspects of the invention will be apparent from and elucidated with reference to the embodiments(s) described hereinafter.

FIG. 1 illustrates in block diagram form a telecommunication system according to the invention comprising a transmitting unit according to the invention and a receiving unit according to the invention,

FIG. 2 illustrates in block diagram form a first receiving unit according to the invention,

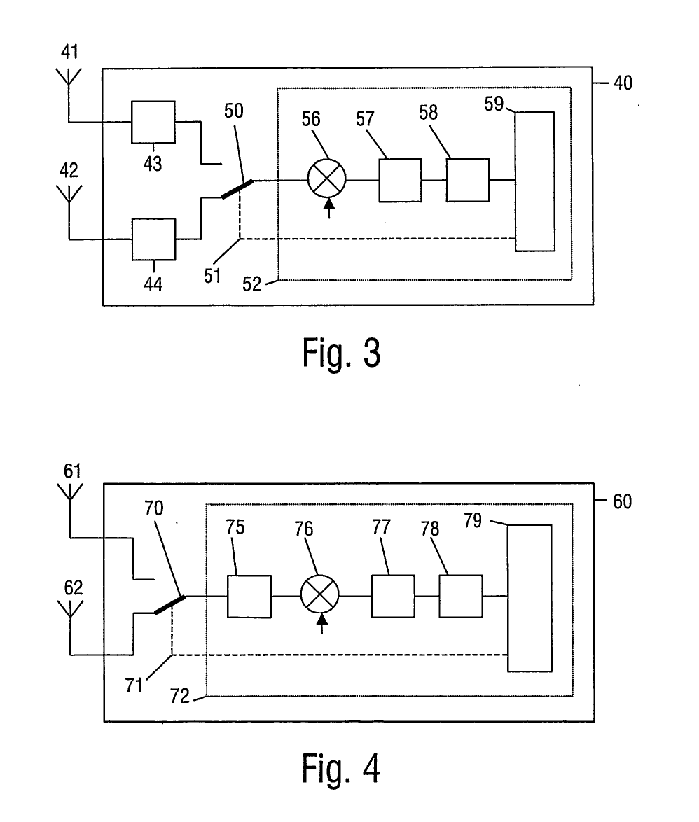

FIG. 3 illustrates in block diagram form a second receiving unit according to the invention, and

FIG. 4 illustrates in block diagram form a third receiving unit according to the invention.

The telecommunication system shown in FIG. 1 comprises a transmitting unit 1 according to the invention and a receiving unit 11 according to the invention.

Transmitting unit 1 comprises a first transmitting chain 2 comprising or coupled to a first transmitting antenna 7 and a second transmitting chain 3 comprising or coupled to a second transmitting antenna 8 and a third transmitting chain 4 comprising or coupled to a third transmitting antenna 9. Inputs of said transmitting chains 2-4 are coupled to subcontacts of a switch 6, of which a main contact is coupled to a processing part 5.

Receiving unit 11 comprises a first receiving chain 12 comprising or coupled to a first receiving antenna 17 and a second receiving chain 13 comprising or coupled to a second receiving antenna 18 and a third receiving chain 14 comprising or coupled to a third receiving antenna 19. Inputs of said receiving chains 12-14 are coupled to subcontacts of a switch 16, of which a main contact is coupled to a processing part 15.

The telecommunication system shown in FIG. 1 is for example a Multi Input Multi Output or MIMO system, in which transmitting unit 1 comprises a first number like for example three transmitting chains 2-4 for parallelly transmitting data, and in which receiving unit 11 comprises a second number like for example three receiving chains 12-14 for parallelly receiving data, with said second number being equal to or being different from said first number, and with at least one of said numbers being larger than one. By using parallel chains, enhancement of the data rate and/or the channel capacity can be achieved, under the main assumption that noise in these parallel chains is uncorrelated, with the correlation in the data being known. But when for example realized on silicon with all chains being located on the same die, a noise source elsewhere on the silicon will introduce correlated noise in the chains. Or when sharing the same synthesizer, this synthesizer will introduce correlated noise in the chains. Said correlated noise lowers the data rate and/or the channel capacity.

By providing transmitting unit 1 (receiving unit 11) with switch 6 (switch 16), which switch 6 (switch 16) is located serially between transmitting chains 2-4 (receiving chains 12-14) and processing part 5 (processing part 15), first transmitting chain 2 (receiving chain 12) is coupled during a first interval to processing part 5 (processing part 15) and second transmitting chain 3 (receiving chain 13) is coupled during a second time interval to processing part 5 (processing part 15) and third transmitting chain 4 (receiving chain 14) is coupled during a third time interval to processing part 5 (processing part 15). As a result, any correlated noise present in the transmitting chains 2-4 (receiving chains 12-14) is no longer correlated, due to said correlated noise in said first transmitting chain 2 (receiving chain 12) for the rest of the transmitting unit 1 (receiving unit 11) only being present during the first time interval and said correlated noise in said second transmitting chain 3 (receiving chain 13) for the rest of the transmitting unit 1 (receiving unit 11) only being present during the second time interval and said correlated noise in said third transmitting chain 4 (receiving chain 14) for the rest of the transmitting unit 1 (receiving unit 11) only being present during the third time interval.

Said switch 6 (switch 16) for example samples, oversamples or subsamples signals destined for the transmitting chains 2-4 (originating from the receiving chains 12-14), and is for example realized low costly and well implementable through a demultiplexer in case of being located in the transmitting unit 1 (through a multiplexer in case of being located in the receiving unit 11).

The invention is based upon an insight, inter alia, that external noise sources will cause correlated noise in the chains in case of all chains being activated all the time, and is based upon a basic idea, inter alia, that this correlated noise can be made uncorrelated by activating one chain and at the same time deactivating all other chains during (subsequent) time intervals.

The invention solves the problem, inter alia, of providing a telecommunication system as defined in the preamble which can handle noise sources introducing correlated noise in the chains, and is advantageous, inter alia, in that the data rate and/or the channel capacity can be optimal.

It should be noted that transmitting unit 1 and receiving unit 11 do not necessarily need to have the same number of chains, and that each one of said units can be used completely independently of the other one of said units.

The first receiving unit 20 shown in FIG. 2 comprises a first antenna 21 coupled to or forming part of first receiving chain 23 and a second antenna 22 coupled to or forming part of second receiving chain 24. First receiving chain 23 comprises a low noise amplifier 25 located between first antenna 21 and a mixer 27, which mixer 27 is coupled to a first subcontact of a switch 30. Second receiving chain 24 comprises a low noise amplifier 26 located between second antenna 22 and a mixer 28, which mixer 28 is coupled to a second subcontact of a switch 30. A main contact of switch 30 is coupled to a processing part 32 comprising a bandpass filter 37 coupled to said main contact and comprising an Analog-to-Digital (AD) converter 38 located between said bandpass filter 37 and a processor 39, which controls switch 30 via control coupling 31.

The second receiving unit 40 shown in FIG. 3 comprises a first antenna 41 coupled to or forming part of first receiving chain 43 and a second antenna 42 coupled to or forming part of second receiving chain 44. First receiving chain 43 comprises a low noise amplifier 43, which low noise amplifier 43 is coupled to a first subcontact of a switch 50. Second receiving chain 44 comprises a low noise amplifier 44, which low noise amplifier 44 is coupled to a second subcontact of a switch 50. A main contact of switch 50 is coupled to a processing part 52 comprising a mixer 56 coupled to said main contact and comprising a bandpass filter 57 located between said mixer 56 and an Analog-to-Digital (AD) converter 58 which is further coupled to a processor 59, which controls switch 50 via control coupling 51.

The third receiving unit 60 shown in FIG. 4 comprises a first antenna 61 coupled to or forming part of first receiving chain 61 and a second antenna 62 coupled to or forming part of second receiving chain 62. First antenna 61 is coupled to a first subcontact of a switch 70. Second antenna 62 is coupled to a second subcontact of a switch 70. A main contact of switch 70 is coupled to a processing part 72 comprising an amplifier 75 coupled to said main contact and comprising a mixer 76 located between said amplifier 75 and a bandpass filter 77 which is further coupled to an Analog-to-Digital (AD) converter 78 which is further coupled to a processor 79, which controls switch 70 via control coupling 71.

Said switch 30 (50 or 70) for example samples, oversamples or subsamples signals originating from the receiving chains 23,24 (43,44 or 61,62), and is coupled via a control coupling 31 (51 or 71) to processing part 32 (52 or 72) for controlling purposes. Then, the switching can be done randomly or programmedly, with said processing part 32 (52 or 72) and said switch 30 (50 or 70) always operating synchronically. Said switch 30 (50 or 70) for example comprises a multiplexer, and is realized low costly and well implementable.

In the embodiment shown in FIG. 2, said receiving chains 23,24 each comprise antenna 21,22, amplifier 25,26 and mixer 27,28, which mixer 27,28 is coupled via switch 30 to processing part 32 comprising filter 37, converter 38 and processor 39. The analog chains 23,24 each comprise a high number of analog components, which is a disadvantage, but correlated noise present in all these analog components is uncorrelated, which is very advantageous.

In the embodiment shown in FIG. 3, said receiving chains 43,44 each comprise antenna 41,42 and amplifier 43,44, which amplifier 43,44 is coupled via switch 50 to processing part 52 comprising mixer 56, filter 57, converter 58 and processor 59. The analog chains 23,24 each comprise an average number of analog components, which is advantageous compared to comprising the high number of analog components, and correlated noise present in all these analog components is uncorrelated, which is very advantageous.

In the embodiment shown in FIG. 4, said receiving chains 61,62 each comprise antenna 61,62, which antenna 61,62 is coupled via switch 70 to processing part 72 comprising amplifier 75, mixer 76, filter 77, converter 78 and processor 79. The analog chains 61,62 each comprise a low number of analog components, which is very advantageous, and correlated noise present in these analog components is uncorrelated, which is very advantageous too. In case of switch 70 being coupled directly to the amplifier 75 the amplifier noise could however be increased disadvantageously, but future technology will take care of that problem.

Further analog components can be added to said chains and further analog and/or digital components can be added to said processing parts without departing from the scope of this invention, which is not limited to Multi Input Multi Output systems or MIMO systems, but which could also be used in cellular radio systems (GSM, UMTS etc.), wireless radio systems (DECT etc.), wireless networks (LANs, WANs etc.), antenna diversity systems etc. In general, the invention solves the problem of having correlated noise at two locations by switching and/or time-multiplexing and/or activating/deactivating said locations for making said correlated noise uncorrelated.

1. Telecommunication system comprising a transmitting unit and a receiving unit, with at least one unit comprising at least two chains coupled to a processing part, characterized in that said chains are coupled to said processing part via at least one switch for uncorrelating correlated noise in said chains.

2. Telecommunication system according to claim 1, characterized in that said switch samples, oversamples or subsamples signals destined for and/or originating from said chains.

3. Telecommunication system according to claim 2, characterized in that said switch is further coupled to said processing part for controlling purposes.

4. Telecommunication system according to claim 1, characterized in that said switch comprises a demultiplexer and/or a multiplexer.

5. Telecommunication system according to claim 4, characterized in that said chains each comprise an antenna, an amplifier and a mixer, which mixer is coupled via said switch to said processing part comprising a filter, a converter and a processor.

6. Telecommunication system according to claim 4, characterized in that said chains each comprise an antenna and an amplifier, which amplifier is coupled via said switch to said processing part comprising a mixer, a filter, a converter and a processor.

7. Telecommunication system according to claim 4, characterized in that said chains each comprise an antenna, which antenna is coupled via said switch to said processing part comprising an amplifier, a mixer, a filter, a converter and a processor.

8. Method for exchanging signals in a telecommunication system comprising a transmitting unit and a receiving unit, with at least one unit comprising at least two chains, characterized in that said method comprises the step of uncorrelating correlated noise in said chains through switching.

9. Transmitting unit comprising at least two transmitting chains coupled to a transmitting processing part, characterized in that said transmitting chains are coupled to said transmitting processing part via at least one switch for uncorrelating correlated noise in said transmitting chains.

10. Receiving unit comprising at least two receiving chains coupled to a receiving processing part, characterized in that said receiving chains are coupled to said receiving processing part via at least one switch for uncorrelating correlated noise in said receiving chains.

11. Transmitting method for uncorrelating correlated noise in transmitting chains of a transmitting unit comprising said transmitting chains, characterized in that said transmitting method comprises the step of switching said transmitting chains for uncorrelating correlated noise in said transmitting chains.

12. Receiving method for uncorrelating correlated noise in receiving chains of a receiving unit comprising said receiving chains, characterized in that said receiving method comprises the step of switching said receiving chains for uncorrelating correlated noise in said receiving chains.
